(19) United States
(12) Patent Application Publication
(10) Pub. No.: US 2008/0162782 A1
(43) Pub. Date: Jul. 3, 2008

(54) Using Transacted Writes and Caching Mechanism to Improve Write Performance in Multi-Level Cell Flash Memory

(76) Inventors: Nagarajan Suresh, Mather, CA (US); Hongyu Wang, Shanghai (CN)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/591,933

(22) PCT Filed: Jun. 15, 2005
(86) PCT No.: PCT/CN2005/000852

§ 371 Date: Sep. 6, 2006

(51) Int. Cl. G06F 12/00

(52) U.S. Cl. 711/103; 711/E12.001

(57) ABSTRACT

A method of writing a file to a flash memory is disclosed in which the file includes a number of data fragments and at least one sequence table. The method comprises writing the data fragments to a non-volatile memory; writing the at least one sequence table including sequence table entries which identifies locations of the data fragment written to the non-volatile memory to a volatile memory, and writing the sequence table from the volatile memory to the non-volatile memory if the sequence table is full or if writing the data fragments of the file is completed.

### BACKGROUND

Non-volatile memory products for electronic equipments, such as cell phones, digital cameras, computers, etc., are widely used today. When writing a file to the non-volatile memory, data fragments, sequence tables and their associated headers may be written to the non-volatile memory one by one. Here, the data fragments store user data of the file and the sequence tables may comprises sequence table entries to store memory locations of the data fragments. A sequence table entry may comprise a data field for a memory location, and, an entry allocating field and entry valid field to protect the sequence table entry in case of power loss.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a memory writing device;

FIG. 2 illustrates an embodiment of a file system maintained in a non-volatile memory of the memory writing device of FIG. 1;

FIG. 3 illustrates an embodiment of a sequence table temporarily stored in a volatile memory of the memory writing device of FIG. 1;

FIG. 4a illustrates a transaction indicator in the file system of FIG. 2;

FIG. 4b illustrates a sequence table entry in the file system of FIG. 2;

FIG. 4c illustrates a sequence table header in the file system of FIG. 2;

FIG. 4d illustrate a data fragment header in the file system of FIG. 2;

FIG. 5 illustrates an embodiment of a memory writing method that may be used by the device of FIG. 1;

FIG. 6 illustrates a comparison between two memory writing methods.

### DETAILED DESCRIPTION

The following description describes techniques for memory writing method and system. In the following description, numerous specific details such as logic implementations, pseudo-code, means to specify operands, resource partitioning/sharing/duplication implementations, types and interrelationships of system components, and logic partitioning/integration choices are set forth in order to provide a more thorough understanding of the present invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

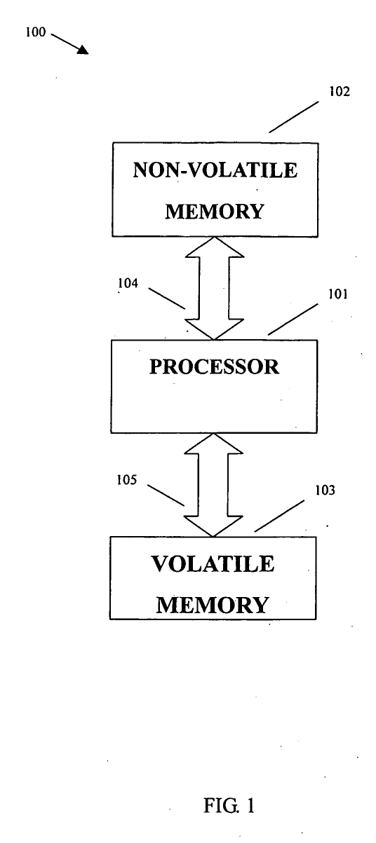

FIG. 1 shows a memory writing device 100 according to one embodiment. The device 100 includes a processor 101, a non-volatile memory 102, and a volatile memory 103. The processor 101 may be any type of processor adapted to perform operations to the non-volatile memory 102. For example, the processor 101 may be a microprocessor, a digital signal processor, a microcontroller, or the like. The non-volatile memory 102 may comprises a flash memory, such as NOR flash memory, NAND flash memory. A volatile memory 103 may comprises various types of random access memories (RAMs), for example, dynamic random access memory (DRAM), synchronous direct random access memory (SDRAM), double data rate (DDR) SDRAMs, or other memories.

The processor 101, the non-volatile memory 102 and the volatile memory 103 may be coupled by buses 104-105. In some embodiments, the processor 101, the non-volatile memory 102 and the volatile memory 103 may be included on an integrated circuit board, and the buses 104-105 may be implemented using traces on the circuit board.

According to various embodiments, the processor 101 may perform operations to non-volatile memory 102 and volatile memory 103. In one embodiment, the processor 101 may control writing a partial file or a whole file to the non-volatile memory 102. The file may comprise a plurality of data fragments, at least one sequence table including a plurality of sequence table entries to identify memory locations of the data fragments, and other associated information. Before being written to the non-volatile memory 102, the sequence table entries may be temporarily stored to the volatile memory 103 and then may be transferred from the volatile memory 103 to the non-volatile memory 102 under the control of the processor 101.

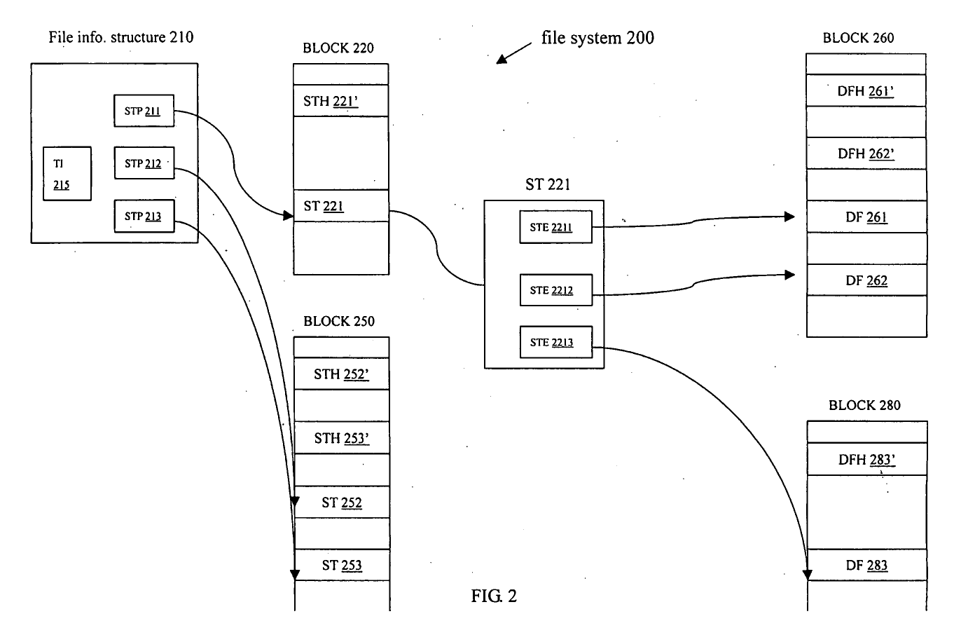

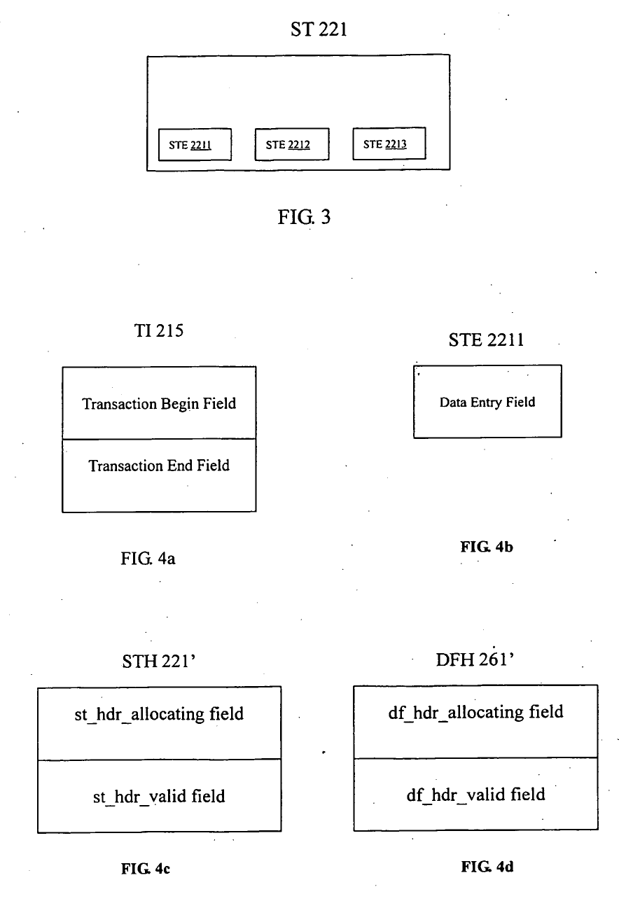

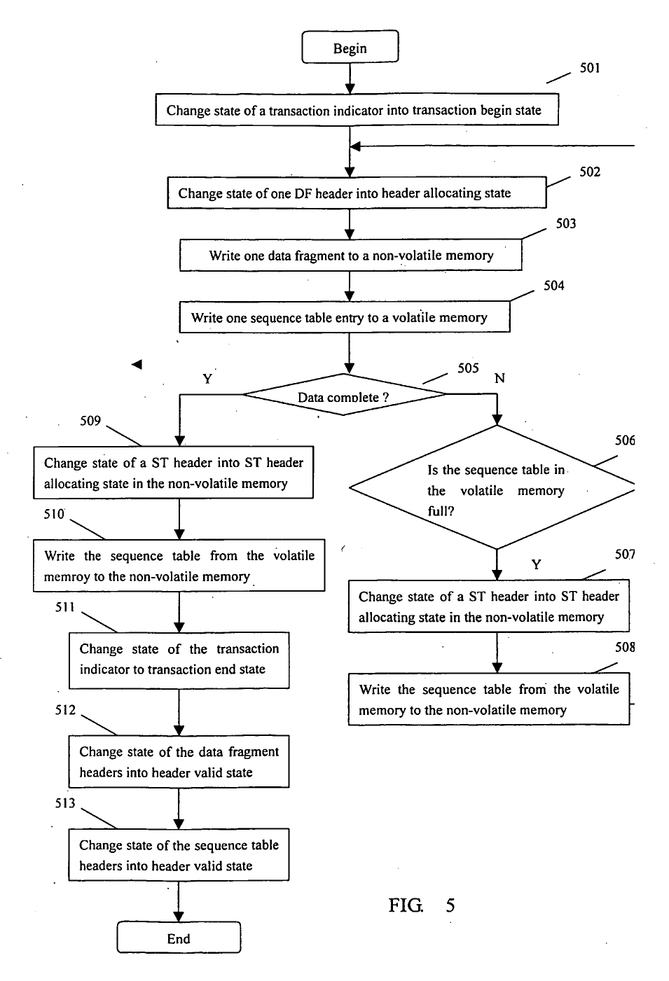

Referring now to FIGS. 2-3 and FIGS. 4a-4d, a file system of the non-volatile memory 102 and a sequence table temporarily stored in the volatile memory 103 will be described in detail. FIGS. 2 and 3 respectively show the file system stored in the non-volatile memory 102 and the sequence table temporarily stored in the volatile memory 103. FIGS. 4a-4d respectively show a transaction indicator (TI), sequence table entry (STE), sequence table header (STH) and data fragment header (DFH) of the file system shown in FIG. 2.

According to various embodiments, the file system 200 maintained in the non-volatile memory may hold files written to the non-volatile memory and any associated information about the files. The file system 200 may include a file information structure 210 and a number of storage blocks 220, 250, 260 and 280, etc. For NOR flash memory manufactured by Intel Corporate, Santa Clara, Calif., a storage block may comprise 64 k or 128 k bytes. For NAND flash memory manufactured by SAMSUNG, Korea, a block may comprise 16 k or 32 k bytes. As shown in FIG. 2, the file information structure 210 may include a transaction indicator (TI) 215 to indicate states of a transaction for writing a file to the non-volatile memory 102, including a begin state and end state of the transaction. The file information structure 210 may further include a number of sequence table pointers (STP) (e.g., STPs 211, 212 and 213) to respectively point to sequence tables (ST) in the storage blocks of the non-volatile memory 102 (e.g., STs 221, 252 and 253 in the storage blocks 220 and 250). The file information structure 210 may also include the filename, creation date, size of a file, or any other information relating to a file. Storage blocks 220, 250, 260 and 280 may represent blocks of memory of the non-volatile memory 102. In some embodiments, each storage block may be divided into a number of fragments to hold a portion of a file. For example, as shown in FIG. 2, storage blocks 220 and 250 may include fragments to hold the sequence tables (e.g., STs 221, 252 and 253) of the file, and storage blocks 260 and 280 may include fragments to hold user data (e.g., data fragments 261, 262 and 283) of the file. For NOR flash memory manufactured by Intel Corporate, Santa Clara, Calif., US, a fragment may comprise 512 or 1 k bytes. It shall be understood that storage blocks may be used to hold other data than those of the file.

Moreover, each sequence table may have a sequence table header (STH) associated therewith, and each data fragment may have a data fragment header (DFH) associated therewith. For example, as shown in FIG. 2, the sequence tables (ST) 221, 252 and 253 have their individually associated headers, i.e., the sequence table headers (STH) 221′, 252′ and 253′. Similarly, the data fragments (DF) 261, 262 and 283 have their individually associated headers, i.e., the data fragment headers (DFH) 261′, 262′ and 283′. Detailed structure of the sequence table (ST) 221 is shown in FIG. 2. For simplicity, detailed structures of the sequence tables (ST) 252 and 253 which are the same as that of the sequence table (ST) 221 are omitted in FIG. 2. As depicted, the sequence table 221 may include a number of sequence table entries (STE), for example, sequence table entries (STE) 2211, 2212 and 2213, to store memory locations of corresponding data fragments (DF) 261, 262 and 283. In one embodiment, a sequence table may be the same size as a fragment which may be less than the size of a storage block. Accordingly, a single sequence table may suffice for a file with a small size; however, a file with a relatively large size may include more than one sequence table, such as sequence tables (ST) 221, 252 and 253.

It shall be appreciated that a file in the file system 200 may include any number of storage blocks to hold any number of data fragments and sequence tables. A sequence table may include any number of sequence table entries to point to the data fragments, as long as within its size limitation. The file may further include any other kinds of data structures than those shown in FIG. 2. In, another embodiment, the file information structure 210 of the file system 200 may include a pointer to point to a storage block in the file system 200 which may be used to hold sequence table pointers to point to the sequence tables. The file information structure 210 may further include different transaction indicators for different files in the file system 200. Other embodiments may implement other modifications and variations to the structure of the file system 200.

Detailed structure of the transaction indicator (TI) 215 is shown in FIG. 4a. As depicted, the transaction indicator 215 may include two transaction state fields: a transaction begin field, indicating the begin state of the transaction for writing a file; and a transaction end field, indicating the end state of the transaction. In an embodiment, the transaction begin field may comprises 2 bits to represent the transaction begin state, and the transaction end field may comprises 2 bits to represent the transaction end state.

In an embodiment, the transaction begin field and transaction end field of the transaction indicator (TI) 215 may each include 1 bit. In another embodiment, the transaction begin field may have 2 bits while the transaction end field may have 1 bit. Other embodiments may utilize transaction indicators (TI) 215 having a different structure and/or a different number of bits.

The transaction indicator may support a power loss recovery feature to keep data consistency of the file to be written in the non-volatile memory 102. Particularly, when power loss happens after the transaction for writing the file is started, but before the transaction ends, parts of the file which have been written to the non-volatile memory may be deleted automatically by the power loss recovery feature.

Referring now to FIG. 4b, the detailed structure of the sequence table entry 221 is shown. In FIG. 4b, the sequence table entry may include a data entry field to identify a memory location of a data fragment. Before a sequence table comprising a number of the sequence table entries is written to the non-volatile memory, the sequence table may be temporarily stored in the volatile memory 103. FIG. 3 shows the data structure of a sequence table temporarily stored in the volatile memory 103. It can be seen that the sequence table stored in volatile memory 103 has the same structure as that in the non-volatile memory 102.

Each sequence table has a sequence table header (STH) associated therewith. Detailed data structure of the sequence table header 221′ is shown in FIG. 4c. In FIG. 4c, the sequence table header has two fields representing two sequence table header states: a sequence table header allocating field (st_hdr_allocating field) to represent ‘sequence table header allocating’ state; a sequence table header valid field (st_hdr_valid field) to represent ‘sequence table header valid’ state. Data structures of the sequence table headers 252′ and 253′ are the same as that of the sequence table header 221′.

Each data fragment may have a data fragment header (DFH) associated therewith. Detailed data structure of the data fragment header 261′ is shown in FIG. 4d. As depicted, the data fragment header may include two fields representing two data fragment header states: a data fragment header allocating field (df_hdr_allocating field) to represent ‘data fragment header allocating’ state; a data fragment header valid field (df_hdr_valid field) to represent ‘data fragment header valid’ state. The data structures of the data fragment headers (DFH) 262′ and 283′ may be implemented in a manner similar to the data fragment header (DFH) 261′.

It shall be appreciated that the sequence table header and/or data fragment header may further include other data structures, such as a header invalid field (hdr_invalid field) to represent ‘header invalid’ state. The sequence table header and data fragment header may support a power loss recovery feature for their associated sequence table and data fragment in the non-volatile memory 102. Namely, if power loss happens before validation of a header, its associated sequence table or data fragment may be deleted automatically.

Now referring to FIG. 5, a method of writing a file to the non-volatile memory according to an embodiment will be described in detail below, the file having the data structure as shown in FIG. 2. The method may be implemented by the device 100 as shown in FIG. 1.

In block 501, the processor 101 may start a transaction for writing a file by changing state of the transaction indicator (TI) 215 in the non-volatile memory 102 to a transaction begin state. For implementation, in an embodiment where the transaction indicator 215 includes a transaction begin field having 2 bits to identify the transaction begin state, the processor 101 may write to the transaction begin field, thereby changing the 2 state bits in the transaction begin field from “11” to “00” to indicate begin of the transaction for writing the file. This change from “11” to “00” may be accomplished using bit twiddling write mode which is a special word programming write mode supported by some non-volatile memory devices. Namely, only two bits of a word are programmed in the bit twiddling mode. However, other embodiments may utilize a different data structure of the transaction indicator and/or a different write mode.

In block 502, the processor 101 may control changing state of a data fragment header (e.g., DFH 261′ in FIG. 2) to a ‘data fragment header allocating’ state which indicates a fragment of a block in the non-volatile memory 102 is allocated to hold a data fragment of the file. Again, this change in state may be accomplished by writing to a data fragment header allocating field (df_hdr_allocating field) of the data fragment header in bit twiddling write mode.

In block 503, the processor 101 may control writing to the non-volatile memory 102 a data fragment associated with the data fragment header in block 502. For example, as shown in FIG. 2, data fragment (DF) 261 associated with data fragment header (DFH) 261′ in block 502 may be written to the non-volatile memory in block 503. This writing of the data fragment may be accomplished in one embodiment with buffer programming write mode to write user data of the file.

In block 504, the processor 101 may control writing a sequence table entry to the volatile memory 103. The sequence table entry may comprise a data entry field to identify the memory location of the corresponding data fragment written in block 503. For example, the sequence table entry (STE) 2211 as shown in FIG. 3, which identifies the memory location of the corresponding data fragment (DF) 261 written in block 503, may be written to the volatile memory 103 in block 504. Since the sequence table entry may be written to a volatile memory, the sequence table entry may not need to add power loss recovery information for each sequence table entry. That is to say, the sequence table entry may not comprise fields to identify entry states, such as entry allocating state and entry valid state, for the purpose of power loss recovery.

In block 505, the processor 101 may determine whether all of the data fragments which carry user data of the file are written to the non-volatile memory. Namely, the processor 101 may determine whether writing the user data of the file to the non-volatile memory is completed. If not, the processor 101 may continue to block 506 where the processor 101 may determine whether the sequence table temporarily stored in the volatile memory 103 (e.g., sequence table 221 in FIG. 3) is full. Since a sequence table may have a limited size, a file with a large size may need more than one sequence table to accommodate a large amount of sequence table entries to identify the memory locations for all of the data fragments of the file. If the processor 101 determines that the sequence table temporarily stored in the volatile memory 103 in not full, the processor 101 may return to block 502 to allocate another data fragment. Namely, the processor 101 may continue to write data fragments to the non-volatile memory 102 and to write their corresponding sequence table entries to the volatile memory 103.

If the sequence table stored in the volatile memory 103 is determined to be full in block 506, the processor 101 may continue to block 507 to allocate another sequence table header. Namely, the processor 101 in block 507 may change state of a sequence table header to ‘sequence table header allocating’ state in the non-volatile memory 102, indicating that a fragment of a block in the non-volatile memory is allocated to hold a sequence table which may be written to the non-volatile memory. For example, the sequence table 221 temporarily stored in the volatile memory 103 (STH) 221′ in FIG. 2 may be changed to a ‘sequence table header allocating’ state. This change in state may be implemented in one embodiment by writing a sequence table header allocating field (st_hdr_allocating field) of the sequence table header (STH) 221′ in bit twiddling write mode.

Then, in block 508, the processor 101 may control writing of the sequence table temporarily stored in the volatile memory 103 to the non-volatile memory 102. For example, the sequence table (ST) 221 in FIG. 3 may be written from the volatile memory to the non-volatile memory in block 508. This writing of the sequence table may be implement in one embodiment with buffer programming write mode. By completion of block 508, a part of the file corresponding to one sequence table is written to the non-volatile memory.

Then, the processor 101 may return to block 502 to continue writing other parts of the file corresponding to other sequence tables such as, for example, the sequence tables (ST) 252 and 253 as shown in FIG. 2. However, modifications and variations to the above are possible. For instance, when a size limitation for a sequence table is set to be large enough to accommodate locations of data fragments of the file, blocks 506-508 may be omitted from FIG. 5.

If, in block 505, the processor 101 determines that writing the user data of the file to the non-volatile memory is completed, the processor may continue to block 509. Namely, the processor 101 may control changing state of a sequence table header in the non-volatile memory 102 to a sequence table header allocating state, which indicates a fragment of a block in the non-volatile memory is allocated to hold a sequence table which may be written to the non-volatile memory. In an embodiment that that may utilize more than one sequence table for the file, the fragment allocated in block 509 may be used to hold the last sequence table of the file. For example, a file may comprise three sequence tables (ST) 221, 252 and 253 as shown in FIG. 2. After parts of the file corresponding to the sequence tables 212 and 252 are written to the non-volatile memory 102 and processor 101 is in the process of writing the last part of the file corresponding to the last sequence table 253, the processor 101 may determine that all of the data fragment carrying user data of the file have been written to the non-volatile memory. The processor 101 may change the state of a sequence table header associated with the last sequence table, e.g., sequence table header (STH) 253′ to sequence table header allocating state which indicates a fragment of a storage block is allocated to hold the sequence table 253 in the non-volatile memory 102. This allocating of the sequence table header may be implemented by one embodiment by writing a sequence table header allocating field of the sequence table header (STH) 253′ in bit twiddling write mode.

Then, in block 510, the processor 101 may control writing of the sequence table temporarily stored in the volatile memory 103 to the non-volatile memory 102. In an embodiment, the last sequence table 253 which is temporarily stored in the volatile memory 103 may be written to the non-volatile memory 102 in block 510.

Then, in block 511, the processor 101 may control changing the state of the transaction indicator 215 to a transaction end state. For implementation, in an embodiment where the transaction indicator 215 includes a transaction end field having 2 bits to identify the transaction end state as shown in FIG. 4a, the processor 101 may write to the transaction end field, thereby changing the 2 state bits in the transaction end field from “11” to “00” to indicate end of writing the file. The following table 1 shows how states of the transaction corresponds to the pair of the transaction begin and transaction end fields according with an embodiment.

TABLE 1

| Transaction | Transaction | Transaction |
|---|---|---|
| Begin Field | End Field | State |
| 00 | 11 | begin |
| 00 | 00 | end |

This ending of the transaction may be implemented by an embodiment via a bit twiddling write mode. However, other embodiments may utilize a transaction indicator with a different structure, a different number of bits, and/or a different write mode.

Then, in block 512, the processor 101 may change the state of data fragment headers associated with the data fragments of the file which have been written to the non-volatile memory from header allocating state to a header valid state. Completion of block 512 indicates that the fragments of the blocks, which have been allocated in block 502 to hold the data fragments of the file, are validated. This validation may be implemented by an embodiment by writing header valid fields of the data fragment headers associated with the data fragments, which have been written to the non-volatile memory, in bit twiddling write mode.

Then, in block 513, the processor 101 may control changing state of the sequence table header(s) associated with the sequence table(s) of the file from the sequence table header allocating state to the sequence table header valid state. In an embodiment that the file has only one sequence table, its associated sequence table header is validated in block 513. In another embodiment that the file has more than one sequence tables, their associated sequence table headers are validated in block 513. Completion of block 513 indicates that the fragment(s) of storage block(s), which had been allocated in blocks 507 and/or 509 to hold the sequence table(s) of the file, is validated. This validation may be implemented in one embodiment by writing sequence table header valid field(s) of the sequence table header(s) associated with the sequence table(s) in bit twiddling write mode.

It can be seen from the flow chart of FIG. 5 that the data fragment headers, sequence table header(s) and the transaction indicator may support a power loss recovery feature. Namely, if the power loss occurs when the transaction of writing the file begins but not ends, which corresponding to the state of the transaction indicator is changed to the transaction begin state, the data fragments and sequence table(s) of the file, whose associated headers have not been validated yet, may be deleted from the non-volatile memory 102.

If the power loss occurs when the transaction of writing the file ends, which corresponding to the state of the transaction indicator is changed to the transaction end state, the data fragments and sequence table(s) of the file may be maintained in the non-volatile memory 102 by validating their associated headers. By this way, data consistency for the whole file may be maintained.

However, other embodiments may utilize modifications and variations of the above described power loss recovery feature. For instance, when data consistency is desired on sequence table level but not on file level, the transaction indicator may be omitted. In such case, after each part of a file corresponding to each sequence table is written to the non-volatile memory, including writing data fragments of that part to the non-volatile memory and writing the corresponding sequence table from the volatile memory to the non-volatile memory, each of the associated sequence table header and data fragment headers may be validated.

Pseudo code of power loss recovery initialization in the non-volatile memory according to an embodiment may be:

If (transaction begin but not end) {

Scan the NV-memory to invalidate all new data

}
Else {

Go through sequence table(s) to validate all new

data
}

It shall be well understood by a skilled person in the art that the above-described method may be applied to write a part of a file to the non-volatile memory, but not whole of the file. Then, other parts of the file may be written by using other memory writing methods. In such case, the transaction indicator may indicate begin and end states of a transaction for writing a part of a file to the non-volatile memory. Then, a sequence table of the part of the file may be transferred from the volatile memory to the non-volatile memory if the sequence table is full or all of data fragments of that part of the file have been written to the non-volatile memory.

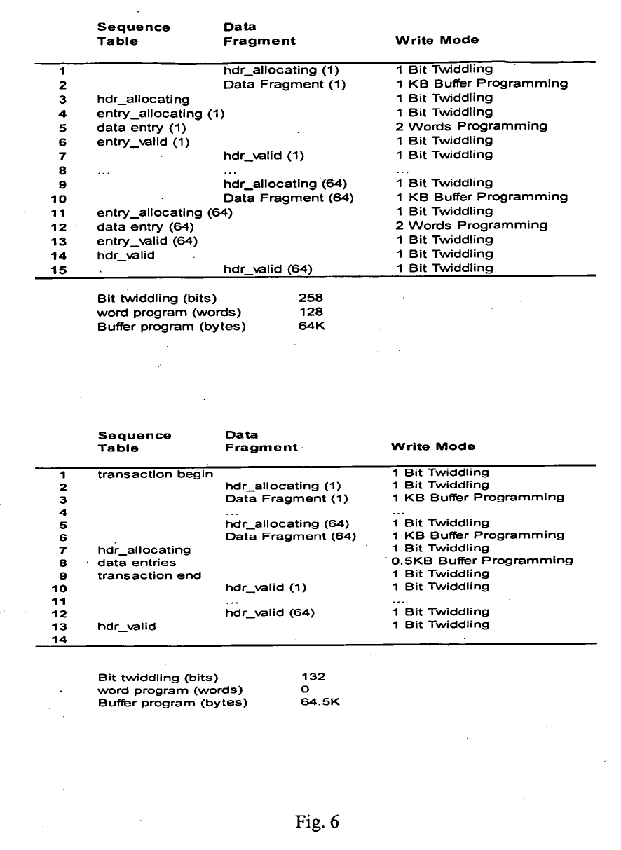

FIG. 6 illustrates the comparison between two memory writing methods wherein a file to be written comprises 64 data fragments and the sequence tables have a sequence table size limit of 64 entries. The upper part of FIG. 5 shows the steps taken to write the file of 64 data fragments according to a first writing method, while the lower part of FIG. 5 shows those according to a second writing method.

It can be seen from FIG. 6 that according to the first writing method, in order to write the file of 64 data fragments, the device 100 as shown in FIG. 1 may perform 256 bit twiddling, 128 word programming and 64 k bytes buffer programming operations, in which the bit twiddling and word programming operations consumes a relatively large amount of time. However, according to the second memory writing method, in order to write the file with the same size, the device 100 as shown in FIG. 1 may only perform 132 bit twiddling, 0 word programming and 64.5 k bytes buffer programming operations, which may significantly save file writing time. It shall be understood that the device 100 may be implemented to utilize both the first file writing method of the second writing method. It shall also be understood that either memory writing method may be applied to write a partial file instead of a whole of the file.

Although the present invention has been described in conjunction with certain embodiments, it shall be understood that modifications and variations may be resorted to without departing from the spirit and scope of the invention as those skilled in the art readily understand. Such modifications and variations are considered to be within the scope of the invention and the appended claims.

What is claimed is:

1. A method, comprising:
writing data fragments to a non-volatile memory; and
updating sequence table entries to a volatile memory that identify locations of the data fragments written to the non-volatile memory.

2. A method of claim 1, further comprising:
writing the sequence table entries to the non-volatile memory.

3. A method of claim 1, further comprising:
writing the sequence table having the sequence table entries to the non-volatile memory if the sequence table is full.

4. A memory of claim 1 further comprising;
writing the sequence table having the sequence table entries to the non-volatile memory if writing the data fragments to the non-volatile memory is completed.

5. A method of claim 1, further comprising:
updating a transaction indicator in the non-volatile memory prior to writing a transaction to the non-volatile memory; and
updating the transaction indicator in the non-volatile memory after writing the transaction to the non-volatile memory,
wherein the transaction comprises the data fragments and the sequence table entries.

6. A method of claims 1, further comprising:
allocating a data fragment header associated to the data fragment in the non-volatile memory prior to writing the data fragment to the non-volatile memory; and
validating the data fragment header after writing the sequence table entries to the non-volatile memory.

7. A method of claim 1, comprising:
allocating a sequence table header associated with the sequence table in the non-volatile memory prior to writing the sequence table to the non-volatile memory; and
validating the sequence table header after writing the sequence table entries to the non-volatile memory.

8. A system, comprising:
a non-volatile memory;
a volatile memory; and
a processor to:
write data fragments to a non-volatile memory; and
update sequence table entries to a volatile memory that identify locations of the data fragments written to the non-volatile memory.

9. A system of claim 8, wherein the processor further writes the sequence table entries to the non-volatile memory.

10. A system of claim 8, wherein the processor further writes the sequence table having the sequence table entries to the non-volatile memory if the sequence table is full.

11. A system of claim 8, wherein the processor further writes the sequence table having the sequence table entries to the non-volatile memory if writing the data fragments to the non-volatile memory is completed.

12. A system of claim 8, wherein the processor further:
updates a transaction indicator in the non-volatile memory prior to writing a transaction to the non-volatile memory; and
updates the transaction indicator in the non-volatile memory after writing the transaction to the non-volatile memory,
wherein the transaction comprises the data fragments and the sequence table entries.

13. A system of claims 8, wherein the processor further:
allocates a data fragment header associated to the data fragment in the non-volatile memory prior to writing the data fragment to the non-volatile memory; and
validates the data fragment header after writing the sequence table entries to the non-volatile memory.

14. A system of claim 8, wherein the processor further:
allocates a sequence table header associated with a sequence table in the non-volatile memory prior to writing the sequence table to the non-volatile memory; and
validates the sequence table header after writing the sequence table entries to the non-volatile memory.

15. A machine-readable medium comprising a plurality of instructions which when executed result in an apparatus:
writing data fragments to a non-volatile memory; and
updating sequence table entries to a volatile memory that identify locations of the data fragments written to the non-volatile memory.

16. The machine-readable medium of claim 15 wherein the plurality of instructions further result in the apparatus:
writing the sequence table entries to the non-volatile memory.

17. The machine-readable medium of claim 15 wherein the plurality of instructions further result in the apparatus:
writing the sequence table having the sequence table entries to the non-volatile memory if the sequence table is full.

18. The machine-readable medium of claim 15 wherein the plurality of instructions further result in the apparatus:
writing the sequence table having the sequence table entries to the non-volatile memory if writing the data fragments to the non-volatile memory is completed.

19. The machine-readable medium of claim 15 wherein the plurality of instructions further result in the apparatus:
updating a transaction indicator in the non-volatile memory prior to writing a transaction to the non-volatile memory; and
updating the transaction indicator in the non-volatile memory after writing the transaction to the non-volatile memory,
wherein the transaction comprises the data fragments and the sequence table entries.

20. The machine-readable medium of claim 15 wherein the plurality of instructions further result in the apparatus:
allocating a data fragment header associated to the data fragment in the non-volatile memory prior to writing the data fragment to the non-volatile memory; and
validating the data fragment header after writing the sequence table entries to the non-volatile memory.

21. The machine-readable medium of claim 15 wherein the plurality of instructions further result in the apparatus:
allocating a sequence table header associated with a sequence table in the non-volatile memory prior to writing the sequence table to the non-volatile memory; and
validating the sequence table header after writing the sequence table entries to the non-volatile memory.
